(19) United States
(12) Patent Application Publication
(10) Pub. No.: US 2023/0285925 A1
(43) Pub. Date: Sep. 14, 2023

(54) QUANTUM DOT MANUFACTURING VESSEL AND QUANTUM DOT MANUFACTURING METHOD USING THE SAME

(71) Applicant: Samsung Display Co., Ltd., Yongin-si (KR)

(72) Inventors: DONGHEE LEE, Hwaseong-si (KR); JAEBOK CHANG, Incheon (KR); SUNGJAE KIM, Cheonan-si (KR); JUO NAM, Hwaseong-si (KR); SEUNG-WON PARK, Seoul (KR); JUNEHYUK JUNG, Gwangmyeong-si (KR)

(21) Appl. No.: 18/097,701

(22) Filed: Jan. 17, 2023

(30) Foreign Application Priority Data
Mar. 11, 2022 (KR) 10-2022-0030987

(51) Int. Cl. B01J 19/00; B01J 19/06; B01J 19/02

(52) U.S. Cl. CPC B01J 19/0013; B01J 19/06; B01J 19/02; B01J 2219/00141; B01J 2219/0263; B01J 2219/0254; B01J 2219/0295; B82Y 40/00

(57) ABSTRACT

A quantum dot synthesizing vessel includes an accommodation part which accommodates a reaction mixture therein, and an outer part which includes a microwave absorbing material and covers the accommodation part, where a plurality of openings exposing at least a portion of the accommodation part is defined in the outer part.

This application claims priority to Korean Patent Application No. 10-2022-0030987, filed on Mar. 11, 2022, and all the benefits accruing therefrom under 35 U.S.C. § 119, the content of which in its entirety is herein incorporated by reference.

### BACKGROUND

### 1. Field

The disclosure herein relates to a quantum dot manufacturing vessel and a quantum dot manufacturing method using the quantum dot manufacturing vessel.

### 2. Description of the Related Art

Various display apparatuses used in multimedia apparatuses such as televisions, mobile phones, tablet computers, navigation systems, and game consoles are being developed. Such a display apparatus uses a so-called self-emission type display element which realizes display by causing a light-emitting material including an organic compound to emit light.

In addition, development of a light-emitting device using quantum dots as a light-emitting material is in progress to improve the color reproducibility of the display apparatus.

### SUMMARY

Recently, research on quantum dots including a plurality of different elements is being conducted to emit light having various wavelengths. Accordingly, a method for effectively manufacturing and producing quantum dots including a plurality of elements is being desired.

The disclosure provides a quantum dot manufacturing vessel capable of synthesizing quantum dots with improved core uniformity.

The disclosure also provides a quantum dot manufacturing vessel capable of mass production and a quantum dot manufacturing method using the quantum dot manufacturing vessel.

An embodiment of the invention provides a quantum dot synthesizing vessel including an accommodation part which accommodates a reaction mixture, and an outer part including a microwave absorbing material and covering an outer surface of the accommodation part, where a plurality of openings is defined in the outer part, and the plurality of openings exposes at least a portion of the accommodation part.

In an embodiment, the outer part may include at least one selected from a perovskite-structured metal oxide, a spinel-structured ferrite type metal oxide, a hexagon-structured ferrite type metal oxide, and a ceramic composite material.

In an embodiment, the perovskite-structured metal oxide may include at least one selected from LaBaMnO₃, LaBaFeMnTiO₃, LaSrMnTMO₃, BaCO₃, Fe₂O₃, and MnCO₃.

In an embodiment, the spinel-structured ferrite type metal oxide may include at least one selected from NiFe₂O₄, BaFe₂O₄, and BaSrFe₂O₄.

In an embodiment, the hexagon-structured ferrite type metal oxide may include at least one selected from BaSrFeMnO₁₉, and BaFeTiMnO₁₉.

In an embodiment, the ceramic composite material may include silicon carbide (SiC).

In an embodiment, the openings may each have a shielding effect (SE) in a range of 0 to 0.5, where the shielding effect (SE) satisfies the following equation:

$$Shielding effect ( SE ) = 20 {log}_{10} ( \frac{λ}{2 d} ) dB ,$$

d>t, where SE denotes the shielding effect, λ denotes a wavelength of microwaves, d denotes a minimum width of each of the openings in one direction, and t denotes a thickness of the outer part.

In an embodiment, a minimum width of each of the openings in one direction may be in a range of about 0.2 millimeter (mm) to about 50 mm.

In an embodiment, in each of the openings, at least about 50% of the microwaves supplied from the outside of the outer part may be delivered to the accommodation part.

In an embodiment, a thickness of the outer part may be less than the minimum width of each of the openings in one direction.

In an embodiment, the reaction mixture may include an organic compound having a boiling point of about 300° C. or higher.

In an embodiment, the plurality of openings may have a same shape as each other.

In an embodiment, each of the plurality of openings may have a shape of a polygon, a circle, or an ellipse on a plane.

In an embodiment, the accommodation part may include at least one selected from glass, quartz, and a polytetrafluoroethylene (PTFE)-based composition.

In an embodiment of the invention, a quantum dot manufacturing method includes providing a cation precursor, an anion precursor, and an organic solvent to a quantum dot synthesizing vessel including an accommodation part, and an outer part which includes a microwave absorbing material and covers an outer surface of the accommodation part, and in which a plurality of openings exposing at least a portion of the accommodation part are defined, mixing the cation precursor, the anion precursor, and the organic solvent in the accommodation part, and raising a temperature of a reaction mixture of the cation precursor, the anion precursor, and the organic solvent by supplying microwaves from an outside of the outer part to the quantum dot synthesizing vessel, and synthesizing quantum dots.

In an embodiment, the raising of the temperature of the reaction mixture and the synthesizing of quantum dots may include delivering the microwaves to the accommodation part through the openings.

In an embodiment, the organic solvent may include at least one selected from octadecene and trioctylphosphine.

In an embodiment, the accommodation part may include at least one selected from glass, quartz, and a PTFE-based composition.

In an embodiment, the outer part may include at least one selected from a perovskite-structured metal oxide, a spinel-structured ferrite type metal oxide, a hexagon-structured ferrite type metal oxide, and a ceramic composite material.

In an embodiment, when the microwaves are supplied from the outside of the outer part to raise the temperature of the reaction mixture and the synthesizing of quantum dots, at least about 50% of the microwaves may be delivered to the accommodation part through the openings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain principles of the invention. In the drawings:

FIG. 1 is a schematic diagram of a quantum dot manufacturing vessel according to an embodiment;

FIG. 2 is a perspective view illustrating a reaction part according to an embodiment;

FIG. 3 is a perspective view illustrating a quantum dot synthesizing vessel according to an embodiment;

FIG. 4 is a cross-sectional view illustrating a part corresponding to line I-I′ of FIG. 3;

FIG. 5 is a cross-sectional view illustrating a part corresponding to region AA of FIG. 3;

FIGS. 6A to 6C are perspective views illustrating a quantum dot synthesizing vessel according to alternative embodiments;

FIG. 7 is a flowchart showing a quantum dot manufacturing method according to an embodiment; and

FIG. 8 shows results of the characteristics of quantum dot synthesizing vessels according to Example and Comparative Example.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

In this specification, when a component (or region, layer, portion, etc.) is referred to as “on”, “connected”, or “coupled” to another component, it means that it is placed/connected/coupled directly on the other component or a third component can be disposed between them.

Meanwhile, in the present application, “directly disposed” may mean that there is no layer, film, region, plate, etc. added between a portion such as a layer, film, region, or plate and another portion. For example, “directly disposed” may mean placing two layers or two members without using an additional member such as an adhesive member therebetween.

Like reference numerals refer to like elements throughout. In addition, in the drawings, thicknesses, ratios, and dimensions of components are exaggerated for effective description of technical content.

Terms such as first and second may be used to describe various components, but the components should not be limited by the terms. These terms are only used for the purpose of distinguishing one component from other components. For example, without departing from the scope of the present invention, a first component may be referred to as a second component, and similarly, a second component may be referred to as a first component. Singular expressions include plural expressions unless the context clearly indicates otherwise.

In addition, terms such as “below”, “lower”, “above”, and “upper” are used to describe the relationship between components shown in the drawings. The terms are relative concepts and are described based on the directions indicated in the drawings.

Unless otherwise defined, all terms (including technical and scientific terms) used in this specification have the same meaning as commonly understood by one of ordinary skill in the art to which this invention belongs. In addition, terms such as terms defined in commonly used dictionaries should be interpreted as having a meaning consistent with the meaning having in the context of the related technology, and should not be interpreted as too ideal or too formal unless explicitly defined here.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in detail with reference to the accompanying drawings.

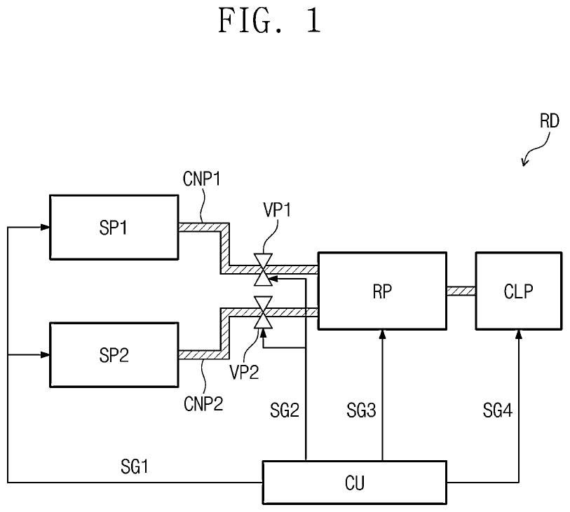

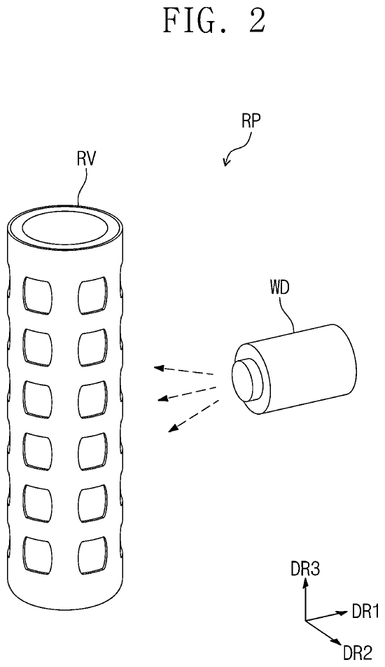

FIG. 1 is a schematic diagram illustrating the configuration of a quantum dot manufacturing device according to an embodiment. FIG. 2 is a perspective view of a reaction part included in the quantum dot manufacturing device according to an embodiment.

Referring to FIG. 1, a quantum dot manufacturing device RD according to an embodiment may include a first supply part SP1 and a second supply part SP2 separated from each other, and a reaction part RP connected to each of the first supply part SP1 and the second supply part SP2. A cooling part CLP may be disposed at an end of the reaction part RP. In addition, the quantum dot manufacturing device RD may further include a control part CU which controls operations of supply parts SP1 and SP2, and the reaction part RP.

Precursors for manufacturing quantum dots may be supplied through the supply parts SP1 and SP2. A cation precursor for manufacturing quantum dots may be supplied through the first supply part SP1 in a form in which the cation precursor is dispersed in an organic solvent having a boiling point of about 300° C. or higher, and an anion precursor may be supplied through the second supply part SP2 in a form in which the anion precursor is dispersed in an organic solvent having a boiling point of about 300° C. or higher. In an embodiment, the organic solvent having a boiling point of about 300° C. or higher may include at least one selected from octadecene and trioctylphosphine.

The cation precursor stored in the first supply part SP1 and supplied through the first supply part SP1 may include at least one selected from In, Ga, and Al. In ions, Ga ions, Al ions, etc., may be included in such a way of being dispersed in a salt form in an octadecene solvent. In an embodiment, for example, in may be supplied in the form of In(OA)₃ in an octadecene solvent, and Ga may be supplied in the form of Ga(OA)₃ in an octadecene solvent. Meanwhile, “OA” corresponds to an oleic acid.

The anion precursor stored in the second supply part SP2 and supplied through the second supply part SP2 may include at least one selected from P, As, N, and Sb. P ions, As ions, N ions, and Sb ions, etc., may be included in such a way of being dispersed in a salt form in a trioctylphosphine solvent. In an embodiment, for example, element P may be supplied in the form of P(TMS)₃ in a trioctylphosphine solvent. Here, “TMS” corresponds to trimethylsilyl.

However, except that the cation precursor and the anion precursor are supplied from the supply parts separated from each other, a state in which the cation precursor and the anion precursor are supplied is not limited to the above-described embodiment. Thus, another organic solvent other than the presented organic solvent may be used, or the precursors may be supplied in other salt forms.

The first supply part SP1 and the second supply part SP2 may respectively control the supply amount of the cation precursor and the supply amount of the anion precursor based on a first control signal SG1 received from the control part CU. The cation precursor supplied by the first supply part SP1 and the anion precursor supplied by the second supply part SP2 may be respectively supplied to the reaction part RP through supply pipes CNP1 and CNP2. A first supply pipe CNP1 and a second supply pipe CNP2 respectively correspond to connection parts between the reaction part RP and the first supply part SP1 and between the reaction part RP and the second supply part SP2. The supply pipes CNP1 and CNP2 may include or be formed of an opaque and highly chemically resistant material. In an embodiment, for example, the supply pipes CNP1 and CNP2 may include or be formed of a stainless steel (SUS) material.

Flow control parts VP1 and VP2 may be disposed between the supply parts SP1 and SP2 and the reaction part RP. The flow control parts VP1 and VP2 may control the supply amounts of the cation precursor and the anion precursor supplied to the reaction part RP. The flow control parts VP1 and VP2 may control the supply rates (or flow rates) of the cation precursor and the anion precursor supplied from the supply parts SP1 and SP2 to the reaction part RP in response to a second control signal SG2 supplied thereto from the control part CU.

In an embodiment, the cation precursor, the anion precursor, and the organic solvent are mixed in the reaction part RP, and a reaction mixture of the cation precursor, the anion precursor, and the organic solvent reacts, thereby synthesizing quantum dots. In such an embodiment, the cation precursor, the anion precursor, and the organic solvent may be stirred and mixed in the reaction part RP. When the cation precursor, the anion precursor, and the organic solvent are mixed, the reaction part RP may be heated to a temperate in a range of about 100° C. to about 150° C. The reaction part RP may include a heating part. The reaction part RP may raise, with microwaves, the temperature of the reaction mixture of the cation precursor, the anion precursor, and the organic solvent. The operation of the reaction part RP may be controlled by a third control signal SG3 supplied thereto from the control part CU. The third control signal SG3 may control the microwave powers, the microwave radiation time, etc., in the reaction part RP.

In an alternative embodiment, the quantum dot manufacturing device RD may include a separate mixing part. In such an embodiment, the cation precursor, the anion precursor, and the organic solvent supplied by the supply parts SP1 and SP2 may be provided to the mixing part through the supply pipes CNP1 and CNP2. In such an embodiment, the cation precursor, the anion precursor, and the organic solvent may be mixed in the mixing part. The reaction mixture of the cation precursor, the anion precursor, and the organic solvent may be provided from the mixing part to the reaction part RP, and quantum dots may be synthesized from the cation precursor and the anion precursor in the reaction part RP.

The quantum dot manufacturing device RD according to an embodiment may further include the cooling part CLP. The cooling part CLP is a part connected to the reaction part RP and may quench the quantum dots synthesized in the reaction part RP. The control part CU may control the temperature of the cooling part CLP by supplying a fourth control signal SG4 thereto. The cooling part CLP may cool the quantum dots in the reaction part RP to a temperature in a range of about 20° C. to about 50° C.

Referring to FIG. 2, the reaction part RP may include a quantum dot synthesizing vessel RV in which the cation precursor, the anion precursor, and the organic solvent are supplied, and the mixing and synthesizing reaction occurs, and a microwave generator WD that supplies microwaves to the quantum dot synthesizing vessel RV.

The quantum dot synthesizing vessel RV may have a cylindrical shape in which at least a portion of one surface thereof is opened, that is, with openings defined through at least a portion of one surface thereof. In an embodiment, an inner space, in which the cation precursor, the anion precursor and the organic solvent may be accommodated, may be defined in the quantum dot synthesizing vessel RV along a third direction DR3. The third direction DR3 may be parallel to a normal direction of a plane defined by a first direction DR1 and a second direction DR2 crossing the first direction DR1. The third direction DR3 may be longitudinal direction of the quantum dot synthesizing vessel RV. The quantum dot synthesizing vessel RV according to an embodiment will be described later in greater detail.

In an embodiment, as shown in FIG. 2 and subsequent drawings, the quantum dot synthesizing vessel RV may have a cylindrical shape, but an embodiment of the invention is not limited thereto. As long as the quantum dot synthesizing vessel RV includes an inner space capable of accommodating the cation precursor, the anion precursor, and the organic solvent and the synthesizing reaction of the cation precursor and the anion precursor is not affected, the quantum dot synthesizing vessel RV may be designed in various forms.

The microwave generator WD may be disposed on at least one side of the reaction part RP. Microwaves supplied by the microwave generator WD may be used as an energy source for synthesizing the cation precursor and the anion precursor. In an embodiment, for example, the microwave generator WD may supply microwaves to the quantum dot synthesizing vessel RV to raise the temperature of the reaction mixture. After the temperature of the reaction mixture accommodated in the quantum dot synthesizing vessel RV is raised by the microwaves supplied from the microwave generator WD, the cation precursor and the anion precursor may react to synthesize quantum dots.

In an embodiment, the microwave generator WD may be disposed spaced apart from the quantum dot synthesizing vessel RV in the first direction DR1, but an embodiment of the invention is not limited thereto. Alternatively, the microwave generator WD may be disposed spaced apart from the quantum dot synthesizing vessel RV in the second direction DR2 or the third direction DR3, or in another direction other than the first direction DR1, the second direction DR2, and the third direction DR3. In an embodiment, as illustrated in FIG. 2, a single microwave generator WD is disposed in the reaction part RP, but an embodiment of the invention is not limited thereto. In an alternative embodiment, for example, an additional microwave generator WD may be further disposed on one side of the quantum dot synthesizing vessel RV to effectively deliver microwaves to the inside of the quantum dot synthesizing vessel RV.

In an embodiment, for example, microwaves generated in the microwave generator WD may have a frequency in a range of about 2.45 gigahertz (GHz) to about 2.56 GHz (that is, a wavelength (λ) of about 0.12 meter (m) to about 0.122 m). However, an embodiment of the invention is not limited thereto, and the frequency and wavelength of microwaves generated by the microwave generator WD may be adjusted depending on the types of quantum dots to be synthesized, and the types of materials included in the reaction mixture, and the microwaves with the adjusted frequency and wavelength may be supplied.

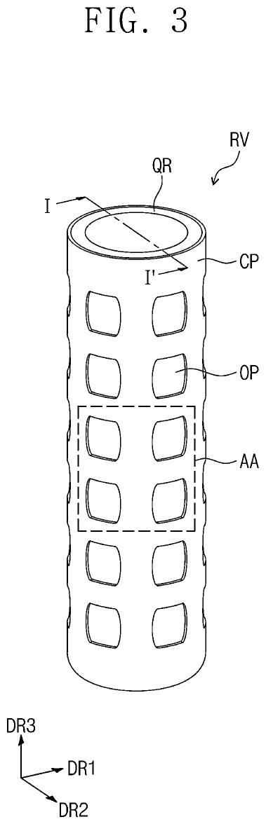

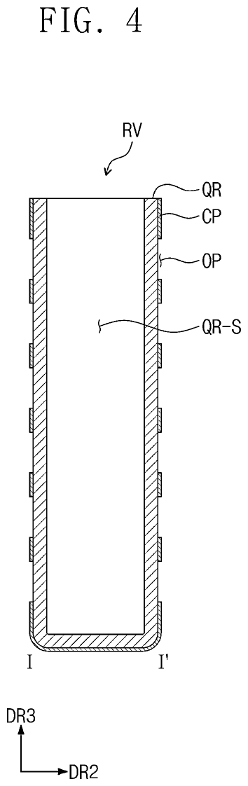

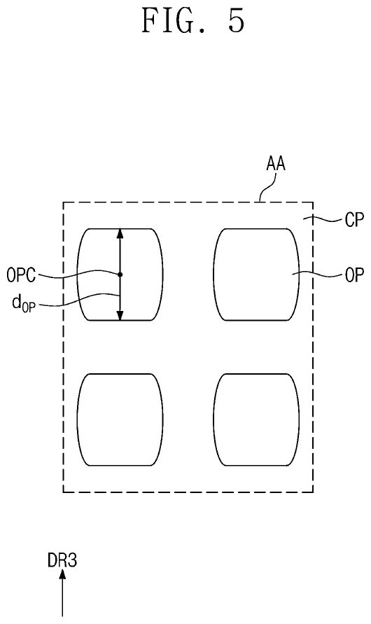

FIG. 3 is a perspective view illustrating a quantum dot synthesizing vessel according to an embodiment. FIG. 4 is a cross-sectional view illustrating a part corresponding to line I-I′ of FIG. 3. FIG. 5 is a cross-sectional view illustrating a part corresponding to region AA of FIG. 3.

Referring to FIGS. 3 and 4, an embodiment of a quantum dot synthesizing vessel RV may include an accommodation part QR in which a cation precursor, an anion precursor, and an organic solvent are provided, and a mixing and synthesizing reaction occurs, and an outer part CP covering the outer surface of the accommodation part QR.

The accommodation part QR may include or be formed of a material through which microwaves are transmitted. In an embodiment, for example, the accommodation part QR may include or be formed of a material such as glass, quartz, or Teflon® (or polytetrafluoroethylene (PTFE)-based composition), but an embodiment of the invention is not limited thereto. As long as a material is a microwave-transmittable material and has chemical resistance to the cation precursor and the anion precursor which are reactants, the material may be used without limitation.

The accommodation part QR may have a cylindrical shape in which at least a portion of one surface thereof is opened. The accommodation part QR includes an inner space QR-S along the third direction DR3, and may thus accommodate the supplied cation precursor, anion precursor, and organic solvent. In the quantum dot synthesizing vessel RV according to an embodiment, the size, area, or the like of the accommodation part QR is not specially limited and the accommodation part QR may be designed to have various size, area, or the like within a range in which the productivity of the quantum dot manufacturing device is not lowered.

The outer part CP may be disposed or formed on the outer surface of the accommodation part QR. The outer part CP may cover the outer surface of the accommodation part QR. The outer part CP may cover the outer surface of the accommodation part QR except for an opened portion which is for supplying the cation precursor, the anion precursor, and the organic solvent. A plurality of openings OP exposing at least a portion of the accommodation part QR may be defined in the outer part CP covering the outer surface of the accommodation part QR.

The outer part CP may include a material having heat resistance and durability, and a characteristic of absorbing microwaves. In an embodiment, for example, the outer part CP may include a metal oxide and/or a composite material that absorbs microwaves. The metal oxide and/or the composite material may convert absorbed microwaves into thermal energy to generate high heat. Since the outer part CP includes a microwave absorbing material such as the metal oxide and/or the composite material, the loss tangent of the organic solvent used for synthesizing quantum dots is small, thereby contributing to rapidly raising the internal temperature of the quantum dot synthesizing vessel RV to the boiling point of the organic solvent or higher, even if the absorbance of the microwaves is low. In an embodiment, for example, since the outer part CP absorbs microwaves and generates heat even if the volume of the mixture accommodated in the accommodation part QR, or the intensity of the supplied microwaves is fixed, the temperature of the reaction mixture accommodated in the accommodation part QR is rapidly raised, thereby contributing to reducing the sizes of synthesized quantum dots and making the wavelength of the quantum dots short. Accordingly, the quantum dot synthesizing vessel RV according to an embodiment including the outer part CP including or formed of a microwave absorbing material may cause heat transfer on the surface thereof without raising the intensity of the microwaves, thereby rapidly synthesizing a large amount of quantum dots at a high temperature.

The outer part CP may include at least one selected from a perovskite-structured metal oxide, a spinel-structured ferrite type metal oxide, a hexagon-structured ferrite type metal oxide, and a ceramic composite material, but an embodiment of the invention is not limited thereto. As long as a material has durability and chemical resistance and absorbs microwaves, the material may be used for the outer part CP without limitation.

In an embodiment, for example, the perovskite-structured metal oxide may include at least one selected from LaBaMnO₃, LaBaFeMnTiO₃, LaSrMnTMO₃, BaCO₃, Fe₂O₃, and MnCO₃. The spinel-structured ferrite type metal oxide may include at least one selected from NiFe₂O₄, BaFe₂O₄, and BaSrFe₂O₄. The hexagon-structured ferrite type metal oxide may include at least one selected from BaSrFeMnO₁₉, and BaFeTiMnO₁₉. The ceramic composite material may include silicon carbide (SiC).

A plurality of openings OP may be defined in the outer part CP, thereby exposing at least a portion of the outer surface of the accommodation part QR. The openings OP may each have a predetermined shape and be arranged spaced apart from each other along the third direction DR3 and along the outer circumferential surface of the accommodation part QR. Microwaves supplied to the quantum dot synthesizing vessel RV through the openings OP may be directly delivered to the inner space QR-S of the accommodation part QR without being fully absorbed to or shielded by the outer part CP.

In an embodiment, the openings OP may each have a shielding effect (SE) in a range of 0 to 0.5 In such an embodiment, the shielding effect (SE) may satisfy the Equation 1 below.

$$Shielding effect ( SE ) = 20 {log}_{10} ( \frac{λ}{2 d} ) dB , \qquad [ Equation 1 ]$$

$$d > t$$

In Equation 1, SE denotes the shielding effect, λ denotes the wavelength of the microwaves, and d denotes the minimum width of each of the openings OP in one direction. In Equation 1, d>t where t denotes the thickness of the outer part CP. The thickness of the outer part CP surrounding the accommodation part QR may be less than the minimum width of each of the openings OP in one direction. In an embodiment, for example, the thickness of the outer part CP may be several nanometers to several thousand nanometers.

In an embodiment, the openings OP may each shield the supplied microwaves of less than about 50%. That is, the amount of the microwaves of about 50% to 100% may be delivered to the accommodation part QR through the openings OP, thereby contributing to improving the uniformity of the internal temperature of the accommodation part QR and the uniformity of quantum dots. Since the microwaves are almost fully absorbed by the outer part CP in a portion of the outer part CP in which the openings OP are not defined, the microwaves may not be substantially delivered to the accommodation part QR.

Referring to FIG. 5, in the outer part CP according to an embodiment, the openings OP may each have various widths depending on the shape. The thickness of the outer part CP may be less than the minimum width of each of the openings OP in one direction. The openings OP may each have a minimum width capable of preventing the microwaves from being not delivered to the inner space QR-S (see FIG. 4) of the accommodation part QR (see FIG. 4) due to absorption or shielding of the microwaves. In an embodiment, for example, the openings OP may each have a width dₒₚ in the third direction DR3 passing through the center OPC. The width of each of the openings OP in the third direction DR3 may be greater than or equal to a minimum width dₒₚ. The minimum width dₒₚ may be in a range of about 0.2 mm to about 50 mm. When the minimum width dₒₚ of each of the openings OP is in the aforementioned range, at least about 50% of the microwaves may transmit through the openings OP, and may be delivered to the inner space QR-S (see FIG. 4) of the accommodation part QR (see FIG. 4). Accordingly, a sufficient amount of the microwaves may be directly delivered to the reaction mixture, thereby uniformly synthesizing quantum dots, and uniformly maintaining the temperature of the inner space QR-S (see FIG. 4). However, an embodiment of the invention is not limited thereto, and the sizes of the openings OP may be adjusted to control the heating rate of the reaction mixture.

In an embodiment, the openings OP may each have a shape of a polygon such as a trigon, a tetragon, or a pentagon, a circle, or an ellipse. The polygon may be a planar figure surrounded by three or more line segments, and may include a form in which vertices are rounded or at least one side is curved in the planar figure. The circle may include a slot hole shape. The openings OP may have a same shape as each other, but an embodiment of the invention is not limited thereto. The openings OP may have various shapes and sizes within a range in which the transmittance of the microwaves delivered to the inner space QR-S (see FIG. 4) is not affected, and may have shapes and sizes different from each other.

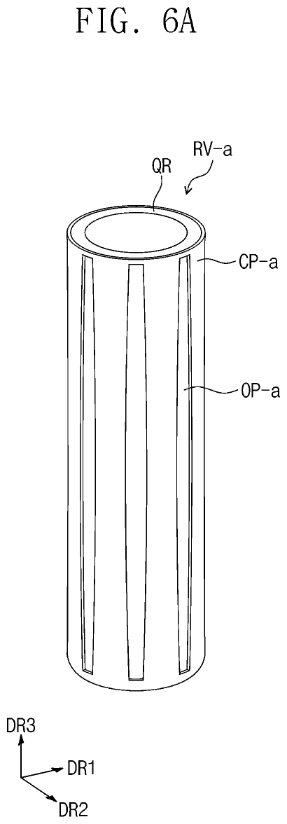

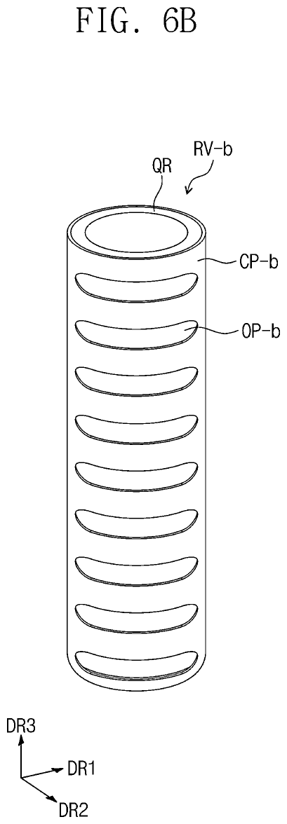

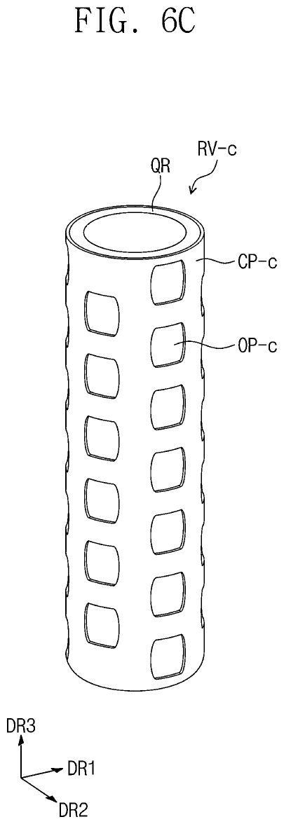

FIGS. 6A to 6C are perspective views illustrating a quantum dot synthesizing vessel according to alternative embodiments. FIGS. 6A to 6C are respectively perspective views illustrating alternative embodiments of the quantum dot synthesizing vessel RV illustrated in FIG. 3, and exemplarily illustrate various shapes of openings OP defined in an outer part CP.

Referring to FIG. 6A, a quantum dot synthesizing vessel RV-a according to an alternative embodiment may include an accommodation part QR, and an outer part CP-a which covers the accommodation part QR, and in which a plurality of openings OP-a are defined. The openings OP-a formed by extending along the third direction DR3 may be defined in the outer part CP-a. The openings OP-a may each substantially have a quadrilateral shape, in which a pair of long sides facing each other may be curved and a pair of short sides facing each other may be linear. The openings OP-a may expose at least a portion of the outer surface of the accommodation part QR. The openings OP-a may be arranged spaced apart from each other by a predetermined interval along the circumference of the outer surface of the accommodation part QR.

Referring to FIG. 6B, a quantum dot synthesizing vessel RV-b according to another alternative embodiment may include an accommodation part QR, and an outer part CP-b which covers the accommodation part QR, and in which a plurality of openings OP-b are defined. The openings OP-b may have a slot hole type circular shape, and may be disposed spaced apart from each other by a predetermined interval along the third direction DR3.

Referring to FIG. 6C, a quantum dot synthesizing vessel RV-c according to another alternative embodiment may include an accommodation part QR and an outer part CP-c which covers the accommodation part QR, and in which a plurality of openings OP-c are defined. The openings OP-c defined in the outer part CP-c may have the same shape and size as the openings OP illustrated in FIG. 3, but may be irregularly arranged on the outer surface of the accommodation part QR. In such an embodiment, the description of the quantum dot synthesizing vessel RV described with reference to FIGS. 2 to 5 may be equally applied to the description of outer parts CP-a, CP-b, and CP-c except for the shape and arrangement of openings OP-a, OP-b, and OP-c.

The openings OP may be each have a predetermined shape, and be arranged spaced apart from each other along the third direction DR3 and/or along the outer circumferential surface of the accommodation part QR.

In an embodiment, as described above with reference to FIGS. 2 to 6C, the quantum dot synthesizing vessel RV, RV-a, RV-b, or RV-c may have a shape in which the openings OP, OP-a, OP-b, and OP-c are defined in the outer part CP, CP-a, CP-b or CP-c, but an embodiment of the invention is not limited thereto. A quantum dot synthesizing vessel including an outer part which includes or is formed of a microwave absorbing material, and in which microwave-transmittable openings are defined in various forms may be used for a quantum dot manufacturing device according to an embodiment.

Quantum dots manufactured from a reaction mixture of a cation precursor, an anion precursor, and an organic solvent supplied to a reaction part RP may be a multi-element compound including three or more elements. The quantum dots manufactured by being synthesized in the reaction part RP of the quantum dot manufacturing device RD according to an embodiment may include a group III-VI semiconductor compound, a group II-VI semiconductor compound, a group III-V semiconductor compound, a group III-VI semiconductor compound, a group semiconductor compound, a group IV-VI semiconductor compound, a group IV element or compound, or any combination thereof.

Examples of the group III-VI semiconductor compound may include a binary compound such as In₂S₃, a ternary compound such as AgInS, AgInS₂, CuInS, or CuInS₂, or any combination thereof.

Examples of the group II-VI semiconductor compound may include a binary compound such as CdS, CdSe, CdTe, ZnS, ZnSe, ZnTe, ZnO, HgS, HgSe, HgTe, MgSe, or MgS, a ternary compound such as CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, or MgZnS, a quaternary compound such as CdZnSeS, CdZnSeTe, CdZnSTe, CdHgSeS, CdHgSeTe, CdHgSTe, HgZnSeS, HgZnSeTe, or HgZnSTe, or any combination thereof.

Examples of the group III-V semiconductor compound may include a binary compound such as GaN, GaP, GaAs, GaSb, AlN, AlP, AlAs, AlSb, InN, InP, InAs, or InSb, a ternary compound such as GaNP, GaNAs, GaNSb, GaPAs, GaPSb, AlNP, AlNAs, AlNSb, AlPAs, AlPSb, InGaP, InNP, InAlP, InNAs, InNSb, InPAs, InPSb, or GaAlNP, a quaternary compound such as GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, or InAlPSb, or any combination thereof. Here, the group III-V semiconductor compound may further include a group II element. Examples of the group III-V semiconductor compound further including the group II element may include InZnP, InGaZnP, InAlZnP, or the like.

Examples of the group III-VI semiconductor compound may include a binary compound such as GaS, GaSe, Ga₂Se₃, GaTe, InS, InSe, In₂Se₃, or InTe, a ternary compound such as InGaS₃, or InGaSe₃, or any combination thereof.

Examples of the group semiconductor compound may include a ternary compound such as AgInS, AgInS₂, CuInS, CuInS₂, CuGaO₂, AgGaO₂, or AgAlO₂, or any combination thereof.

Examples of the group IV-VI semiconductor compound may include a binary compound such as SnS, SnSe, SnTe, PbS, PbSe, or PbTe, a ternary compound such as SnSeS, SnSeTe, SnSTe, PbSeS, PbSeTe, PbSTe, SnPbS, SnPbSe, or SnPbTe, a quaternary compound such as SnPbSSe, SnPbSeTe, or SnPbSTe, or any compound thereof.

The group IV element or compound may include a single element compound such as Si, or Ge, a binary compound such as SiC, or SiGe, or any combination thereof.

Each element included in a multi-element compound such as the binary compound, the ternary compound, and the quaternary compound may be present in a particle with a uniform or non-uniform concentration.

Here, the quantum dots may have a single structure or a core-shell double structure in which the concentration of each element included in the corresponding quantum dot is uniform. For example, a material included in the core and a material included in the shell may be different.

The shells of the quantum dots may serve as a protective layer for maintaining semiconductor characteristics by preventing chemical denaturation of the core, and/or as a charging layer for imparting electrophoretic characteristics to the quantum dots. The shell may be a single- or multi-layer. The interface between the core and the shell may have a concentration gradient in which the concentrations of elements present in the shell decrease toward the center.

Examples of the shell of the quantum dot may be a metal or non-metal oxide, a semiconductor compound, or a combination thereof. Examples of the metal or non-metal oxide may include a binary compound such as SiO₂, Al₂O₃, TiO₂, ZnO, MnO, Mn₂O₃, Mn₃O₄, CuO, FeO, Fe₂O₃, Fe₃O₄, CoO, Co₃O₄, or NiO, a ternary compound such as MgAl₂O₄, CoFe₂O₄, NiFe₂O₄, or CoMn₂O₄, or any combination thereof. As described in the present disclosure, examples of the semiconductor compound may include a group III-VI semiconductor compound, a group II-VI semiconductor compound, a group III-V semiconductor compound, a group III-VI semiconductor compound, a group semiconductor compound, a group IV-VI semiconductor compound, or any combination thereof. For example, the semiconductor compound may include CdS, CdSe, CdTe, ZnS, ZnSe, ZnTe, ZnSeS, ZnTeS, GaAs, GaP, GaSb, HgS, HgSe, HgTe, InAs, InP, InGaP, InSb, AlAs, AlP, AlSb, or any compound thereof.

However, an embodiment of the invention is not limited thereto, and quantum dots to be manufactured may have various types depending on the kinds of a supplied cation precursor and a supplied anion precursor, the intensity of supplied microwaves, the volume of a reaction mixture, or the like.

When using microwaves as an energy source, the quantum dot synthesizing vessel according to an embodiment may increase a heating rate depending on the sizes of openings under a same microwave energy condition. That is, the quantum dot synthesizing vessel according to an embodiment may facilitate controlling of the heating rate, thereby making it easy to synthesize quantum dots and improve characteristics thereof. In addition, the quantum dot synthesizing vessel may uniformly maintain the heating rate, thereby contributing to increasing the limited capacity by tens of times when synthesizing quantum dots once. In addition, the quantum dot synthesizing vessel may directly deliver microwaves to an accommodation part through the openings, thereby improving the uniformity of manufactured quantum dots and achieving an expected effect due to super-heating of an organic solvent.

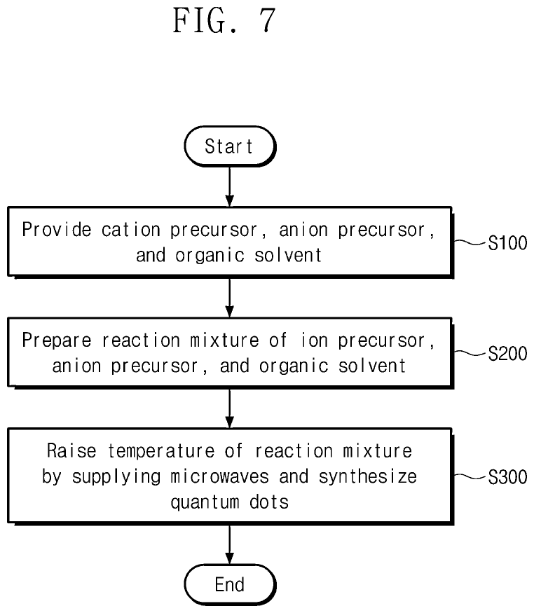

FIG. 7 is a flowchart showing a quantum dot manufacturing method according to an embodiment. The quantum dot manufacturing method according to an embodiment corresponds to a manufacturing method using the quantum dot synthesizing vessel according to the embodiments described above. Hereinafter, the quantum dot manufacturing method will be described in detail with reference to FIG. 7 and with reference to FIGS. 1 to 3 again. Among elements described above with reference to FIGS. 1 to 6C, any repetitive detailed description of the quantum dot synthesizing vessel and the material used for synthesizing quantum dots will be omitted, and the characteristics of the manufacturing method will be mainly described.

The quantum dot manufacturing method according to an embodiment may include an operation (S100) of providing a cation precursor, an anion precursor, and an organic solvent, an operation (S200) of mixing the cation precursor and the anion precursor, and an operation (S300) of raising the temperature of a reaction mixture of the cation precursor, the anion precursor, and the organic solvent by supplying microwaves and synthesizing quantum dots. The quantum dot manufacturing method according to an embodiment may further include an operation of cooling the synthesized quantum dots.

The operation (S100) of providing a cation precursor, an anion precursor, and an organic solvent may be performed using first and second supply parts SP1 and SP2 of a quantum dot manufacturing device RD according to an embodiment described above. The cation precursor and the anion precursor may be each provided from the first supply part SP1 and the second supply part SP2 to a quantum dot synthesizing vessel RV of a reaction part RP. The cation precursor and the anion precursor provided from the first and second supply parts SP1 and SP2 may be each provided in a state in which the cation precursor and the anion precursor are dispersed in the organic solvent, and therefore the cation precursor, the anion precursor, and the organic solvent are substantially provided to the quantum dot synthesizing vessel RV. The cation precursor provided from the first supply part SP1 may include at least one selected from In, Ga, and Al, and the anion precursor provided from the second supply part SP2 may include at least one selected from P, As, N, and Sb.

The cation precursor and the anion precursor respectively provided from the first supply part SP1 and the second supply part SP2, and the organic solvent may be mixed in the quantum dot synthesizing vessel RV according to the embodiment described above. The operation (S200) of mixing the cation precursor, the anion precursor, and the organic solvent may be performed at a temperature in a range of about 100° C. to about 150° C.

The operation (S300) of raising the temperature of the reaction mixture of the cation precursor, the anion precursor, and the organic solvent and to synthesize quantum dots may be performed in the reaction part RP. Since microwaves are supplied to the quantum dot synthesizing vessel RV, the temperature of the reaction mixture of the cation precursor, the anion precursor, and the organic solvent may be raised. The quantum dot synthesizing vessel RV includes an accommodation part QR which accommodates the reaction mixture of the cation precursor, the anion precursor, and the organic solvent, and the outer part CP which covers the accommodation part QR, and in which a plurality of openings OP is defined. In the quantum dot synthesizing vessel RV, the accommodation part QR includes or is formed of a microwave-transmittable material, and the outer part CP includes or is formed of a microwave absorbing material.

In an embodiment, the operation (S300) of raising the temperature of the reaction mixture to synthesize quantum dots may include delivering the microwaves to the accommodation part QR through the openings OP. In an embodiment, for example, a portion of microwaves supplied to the quantum dot synthesizing vessel RV may be directly delivered to the inside of the accommodation part QR after transmitting the accommodation part QR through the openings OP, and the remaining microwaves may be absorbed by the outer part CP. The microwaves delivered to the inside of the accommodation part QR through the openings OP may directly heat the reaction mixture. The microwaves absorbed by the outer part CP may be changed into a thermal energy to generate high heat, and may rapidly raise the internal temperature of the quantum dot synthesizing vessel RV to a higher temperature. A quantum dot including at least one cation included in the cation precursor, and at least one anion included in the anion precursor may be synthesized by directly or indirectly supplying microwaves to the reaction mixture accommodated in the quantum dot synthesizing vessel RV.

In the operation (S300) of raising the temperature of the reaction mixture by supplying microwaves and synthesizing quantum dots, the microwaves supplied to the quantum dot synthesizing vessel RV may have a frequency of about 2.56 GHz (that is, a wavelength (λ) of about 0.12 m). The internal temperature of the quantum dot synthesizing vessel RV irradiated with the microwaves may be rapidly raised to at least the boiling point of the organic solvent accommodated in the quantum dot synthesizing vessel RV. In an embodiment, for example, the organic solvent included in the reaction mixture may have a boiling point of about 300° C. or higher, and in this case, the internal temperature of the quantum dot synthesizing vessel RV may be raised to about 300° C. or higher. The synthesized quantum dots may include the group III-VI semiconductor compound, the group II-VI semiconductor compound, the group III-V semiconductor compound, the group III-VI semiconductor compound, the group semiconductor compound, the IV-VI semiconductor compound, the group IV element or compound, or any combination thereof.

After the operation (S300) of raising the temperature of the reaction mixture by supplying microwaves, and synthesizing quantum dots, the manufacturing method may further include an operation of cooling the synthesized quantum dots. The operation of cooling the synthesized quantum dots may be performed at a temperature in a range of about 20° C. to about 50° C. The quantum dots in a stable state may be obtained by rapidly cooling the quantum dots that have been synthesized in the quantum dot synthesizing vessel RV and ejected.

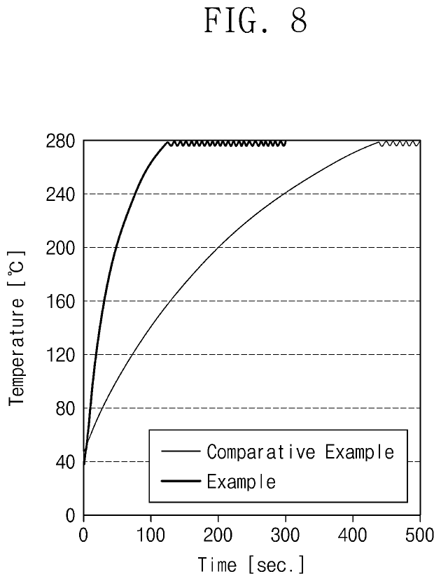

FIG. 8 shows results of the characteristics of a quantum dot synthesizing vessel according to an embodiment. FIG. 8 shows the comparison results of the heating rates of a conventional quantum dot synthesizing vessel (Comparative Example) and the quantum dot synthesizing vessel according to the invention (Example) after supplying microwaves having a same wavelength. In Example shown in FIG. 8, a quantum dot synthesizing vessel having an outer part in which a plurality of openings is defined in the outer surface of the accommodation part formed of glass is used, and silicon carbide is used as an outer part forming material. In Comparative Example, a quantum dot synthesizing vessel having only an accommodation part formed of glass is used. In addition, microwaves having a same intensity of about 2.45 GHz (a wavelength (λ) of about 0.122 m) is supplied to the quantum dot synthesizing vessels according to Example and Comparative Example. Referring to the results of FIG. 8, it is confirmed that the quantum dot synthesizing vessel according to Example raises the temperature more rapidly than the quantum dot synthesizing vessel according to Comparative Example.

Since a quantum dot synthesizing vessel according to an embodiment uses microwaves as an energy source, and the microwaves transmit an accommodation part through openings defined in an outer part and are simultaneously absorbed by the outer part, the temperature of a reaction mixture may be rapidly raised, and a large amount of quantum dots in a short wavelength range may be synthesized without increasing the intensity of the microwaves. The internal temperature of the accommodation part is uniformly maintained, thereby making it possible to synthesize quantum dots having uniform core characteristics. In addition, a quantum dot manufacturing method according to an embodiment using the quantum dot synthesizing vessel according to an embodiment may make it easy to produce quantum dots having uniform core characteristics.

Since a quantum dot synthesizing vessel according to an embodiment uses microwaves as an energy source, and includes an outer part which is formed of a microwave absorbing material and in which a plurality of openings is defined in the outer surface of an accommodation part, the heating rate of a reaction mixture may be increased and be controlled.

A quantum dot manufacturing method according to an embodiment may be used for producing a large amount of quantum dots by using the quantum dot synthesizing vessel according to an embodiment described above, thereby producing quantum dots having uniform core characteristics.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A quantum dot synthesizing vessel comprising:
an accommodation part which accommodates a reaction mixture therein; and
an outer part including a microwave absorbing material and covering an outer surface of the accommodation part, wherein a plurality of openings is defined in the outer part, and the plurality of openings exposes at least a portion of the accommodation part.

2. The quantum dot synthesizing vessel of claim 1, wherein the outer part comprises at least one selected from a perovskite-structured metal oxide, a spinel-structured ferrite type metal oxide, a hexagon-structured ferrite type metal oxide, or a ceramic composite material.

3. The quantum dot synthesizing vessel of claim 2, wherein the perovskite-structured metal oxide comprises at least one selected from LaBaMnO₃, LaBaFeMnTiO₃, LaSrMnTMO₃, BaCO₃, Fe₂O₃, and MnCO₃.

4. The quantum dot synthesizing vessel of claim 2, wherein the spinel-structured ferrite type metal oxide comprises at least one selected from NiFe₂O₄, BaFe₂O₄, and BaSrFe₂O₄.

5. The quantum dot synthesizing vessel of claim 2, wherein the hexagon-structured ferrite type metal oxide comprises at least one selected from BaSrFeMnO₁₉, and BaFeTiMnO₁₉.

6. The quantum dot synthesizing vessel of claim 2, wherein the ceramic composite material comprises silicon carbide (SiC).

7. The quantum dot synthesizing vessel of claim 1, wherein the openings each have a shielding effect (SE) in a range of 0 to 0.5,
wherein the shielding effect (SE) satisfy the following equation:
$$Shielding effect ( SE ) = 20 {log}_{10} ( \frac{λ}{2 d} ) dB ,$$
d>t
wherein
SE denotes the shielding effect,
λ denotes a wavelength of microwaves,
d denotes a minimum width of each of the openings in one direction, and
t denotes a thickness of the outer part.

8. The quantum dot synthesizing vessel of claim 1, wherein a minimum width of each of the openings in one direction is in a range of about 0.2 mm to about 50 mm.

9. The quantum dot synthesizing vessel of claim 8, wherein in each of the openings, at least about 50% of microwaves supplied from the outside of the outer part is delivered to the accommodation part.

10. The quantum dot synthesizing vessel of claim 9, wherein a thickness of the outer part is less than a minimum width of each of the openings in one direction.

11. The quantum dot synthesizing vessel of claim 1, wherein the reaction mixture comprises an organic compound having a boiling point of about 300° C. or higher.

12. The quantum dot synthesizing vessel of claim 1, wherein the plurality of openings has a same shape as each other.

13. The quantum dot synthesizing vessel of claim 1, wherein each of the plurality of openings has a shape of a polygon, a circle, or an ellipse on a plane.

14. The quantum dot synthesizing vessel of claim 1, wherein the accommodation part comprises at least one selected from glass, quartz, and a polytetrafluoroethylene-based composition.

15. A quantum dot manufacturing method, the method comprising:
providing a cation precursor, an anion precursor, and an organic solvent to a quantum dot synthesizing vessel including an accommodation part, and an outer part which includes a microwave absorbing material and covers an outer surface of the accommodation part, and in which a plurality of openings exposing at least a portion of the accommodation part are defined;
mixing the cation precursor, the anion precursor, and the organic solvent in the accommodation part; and
raising a temperature of a reaction mixture of the cation precursor, the anion precursor, and the organic solvent by supplying microwaves from an outside of the outer part to the quantum dot synthesizing vessel, and synthesizing quantum dots.

16. The quantum dot manufacturing method of claim 15, wherein the raising the temperature of the reaction mixture and the synthesizing of quantum dots comprises delivering the microwaves to the accommodation part through the openings.

17. The quantum dot manufacturing method of claim 15, wherein the organic solvent comprises at least one selected from octadecene and trioctylphosphine.

18. The quantum dot manufacturing method of claim 15, wherein the accommodation part comprises at least one selected from glass, quartz, and a polytetrafluoroethylene-based composition.

19. The quantum dot manufacturing method of claim 15, wherein the outer part comprises at least one selected from a perovskite-structured metal oxide, a spinel-structured ferrite type metal oxide, a hexagon-structured ferrite type metal oxide, and a ceramic composite material.

20. The quantum dot manufacturing method of claim 16, wherein when the microwaves are supplied from the outside of the outer part to raise the temperature of the reaction mixture and the synthesizing of quantum dots, at least about 50% of the microwaves is delivered to the accommodation part through the openings.
